(19) United States
(12) Patent Application Publication
(10) Pub. No.: US 2003/0080539 A1
(43) Pub. Date: May 1, 2003

(54) Universal accessory-mounting assembly

(76) Inventors: Jason R. Thompson, Fort Wayne, IN (US); Matthew R. LaFontaine, Fort Wayne, IN (US); William C. Downs, Fort Wayne, IN (US)

Correspondence Address: Jeffrey P. Calfa, International Truck Intellectual, Property Company, L.L.C., 4201 Winfield Rd., Warrenville, IL, 60555, US

(21) Appl. No.: 10/047,827

(22) Filed: Oct. 29, 2001

(51) Int. Cl. B60R 21/00

(52) U.S. Cl. 280/727

(57) ABSTRACT

A universal accessory-mounting assembly for mounting an accessory such as a light, mirror, or antenna at a distance from a base structure such as a body structure of a vehicle is provided. The universal accessory-mounting structure has one or more support components which have a base end that is disposed adjacent the base structure when the universal accessory-mounting assembly is properly mounted. The support components of the universal accessory-mounting assembly also have an accessory-support end to which the accessory is directly or indirectly engaged and from which the accessory derives support directly or indirectly. The universal accessory-mounting assembly has two or more base-attachment structures for attaching it to the base structure. Each of the base attachment structures is engaged to a base end of a support component. One or more of the base-attachment structures is biaxially pivotally engaged through a ball-and-socket joint to the base end of the support component to which it is engaged. Engagement of each one these one or more base-attachment structures to a support component through a ball and socket joint facilitates the mounting of the universal accessory-mounting assembly to base structures of any of a number of different shapes.

### BACKGROUND OF THE INVENTION

The present invention relates to accessory-mounting assemblies for mounting accessories at a distance from a base structure such as a body structure of a vehicle. FIG. 3 shows one example of many different constructions of prior art accessory mounting assemblies to which the present invention generally relates. In particular, the present invention relates to accessory mounting assemblies that have two or more support components that cooperatively support an accessory at a distance from a base structure to which the accessory-mounting assembly is attached. Each of the support components of such accessory-mounting assemblies has a base end and an accessory-support end distant from the base end. The accessory-support ends of the support components are each engaged directly or indirectly to the accessory that is to be supported by the accessory-mounting assembly. The base ends of each of the support components have base-attachment structures that function to engage the accessory-mounting assembly to the base structure. Such accessory-mounting assemblies are generally constructed such that the base ends of its support components can be attached to the base structure at points distant from one another to ensure stability of the position of accessory mounted at a distance from the base structure.

Many known accessory-mounting assemblies include base-attachment structures, at the base ends of the support components, that must have a specific orientation with respect to the portion of the base structure to which they are engaged. The prior art accessory-mounting assembly shown in FIG. 3 is an example of an accessory-mounting assembly that includes base-attachment structures that must have a certain orientation relative to the portion of the base structure to which they are attached. The base-attachment structures of the of the accessory-mounting assembly shown in FIG. 3 include a mounting pad with a flat mounting-face and a male threaded stud that extends, in a direction away from the support component, beyond the flat mounting-face of the mounting pad. When a base-attachment structure of the accessory-mounting assembly of FIG. 3 is properly attached to the base structure, the threaded stud of the base-attachment structure penetrates into or through the base structure and is threadedly engaged to threaded female structure within or upon the opposite side of the base structure. Additionally, when the base-attachment structures of the accessory mounting assembly of FIG. 3 are properly engaged to the base structure, the threaded stud of the base-attachment structures are threadedly engaged to the female threaded structures disposed within or upon an opposite side of the base structure to an extent such that the flat mounting-faces of the mounting pads are firmly urged against the outer surface of the base structure surrounding the threaded studs of the base-attachment structures. Thus, when the base-attachment structures of the accessory-mounting assembly shown in FIG. 3 are properly engaged to a base structure, the flat mounting-faces of the mounting plates must be parallel to the outer surface of the portions of the base structure to which the base-attachment structures are engaged.

In spite of the fact that the base-attachment structures of the accessory-mounting assembly shown in FIG. 3 must have a very specific orientation relative to a portion of a base structure to which they are engaged, the accessory-mounting assembly is a universal accessory-mounting assembly, which can be mounted to base structures with any of a number of different shapes. There are two particular details of the construction of the support components of the accessory-mounting assembly shown in FIG. 3 that enable it to be mounted to base structures of different shapes. The mounting pad of each support component is uniaxially pivotally engaged to the rest of the support component. In other words, each mounting pad is engaged to its respective support component in such a manner that it may pivot about one and only one axis. Additionally, each support component comprises a base-end structure, which is the part of the support component that is uniaxially pivotally engaged to the mounting pad, and accessory-support-end structure, which is disposed at the accessory support end of the support component. The base-end structure and the accessory-support-end structure are uniaxially pivotally engaged to one another with the axis which they can pivot about relative to one another being disposed at an angle to the axis about which the mounting pad can pivot relative to the base-end structure of the support component. Thus, the angle of the flat mounting-face of each mounting pad is infinitely adjustable within a large range by adjusting the angle of the mounting pad relative to the base-end structure and/or the angle of the base-end structure relative to the accessory-support-end structure. The extensive adjustability of the orientation of each of the mounting pads allows for mounting of the accessory mounting assembly to base structures of many different shapes. Construction of the support components of such an accessory-mounting assembly with the base-end structure and the accessory-support-end structure uniaxially pivotally engaged to one another is obviously more expensive, though, than if the base-end structure and the accessory-support-end structure were rigidly engaged to one another such as if they were an integral unit. An accessory-mounting assembly constructed such as the one shown in FIG. 3 except that the base-end structure and the accessory-support-end structures were rigidly engaged to one another would, however, significantly limit the number of different shapes of base structures to which the accessory-mounting assembly could be mounted.

### SUMMARY OF INVENTION

As a result,—an object of the present invention is to provide universal accessory-mounting assembly that is cost effective and simple in construction with respect to prior art universal accessory-mounting assemblies and that can be mounted to any of a number of different constructions of base structures which have outer surfaces with a number of different shapes.

The present invention is a universal accessory-mounting assembly for mounting an accessory at a distance from a surface of a base structure. The universal accessory-mounting assembly of the present invention comprises one or more support components. Each of the support components has a base end and an accessory-support end. The accessory-support end of each of the support components is engaged to the accessory-support end of each of the other support components either directly or indirectly. The universal accessory-mounting assembly also comprises accessory-attachment structure to which an accessory such as a mirror, antenna, light, or other component may be engaged and from which the accessory would derive support when the universal accessory-mounting assembly is properly mounted to a base structure. The accessory-attachment structure is, in turn, engaged directly or indirectly to and derives support from the two or more support components of the universal accessory-mounting assembly. The universal accessory-mounting assembly of the present invention further includes two or more independent base-attachment structures each of which is engaged to the base end of one of the support components. The base-attachment structure at the base end of each of the support components has a construction that enables it to be readily fixedly engaged to a base structure, to which the universal accessory-mounting assembly is to be mounted. At least one of the base-attachment structures of the universal accessory-mounting assembly of the present invention is engaged to the base end of the support component that it is engaged to through a ball-and-socket joint and is, thus, biaxially pivotally engaged to the support component. Because the base attachment structure is biaxially pivotally engaged to the support component its orientation relative to the rest of the universal accessory-mounting assembly and the surfaces of a base structure can be adjusted indefinitely within a wide range of angles about two axes by adjusting its orientation relative to the support component they are engaged to. The large amount of possible adjustment of the orientation of the base-attachment structure relative to the support component it is engaged to makes it unnecessary to enable adjustment of the orientations and positions of the base ends and the accessory-support ends of the support components relative to one another. Thus, the accessory-mounting assembly of the present invention can be mounted to base structures of a number of different shapes and its support components can be of a relatively simple construction compared to prior art universal accessory-mounting assemblies.

Thus, it can be seen that the above-mentioned object of the present invention as well as others not mentioned have been met.

### DRAWINGS

Other objects and advantages of the invention will become more apparent upon perusal of the detailed description thereof and upon inspection of the drawings in which:

FIG. 1 shows the preferred embodiment of a universal accessory-mounting assembly according to the present invention mounted to a base structure.

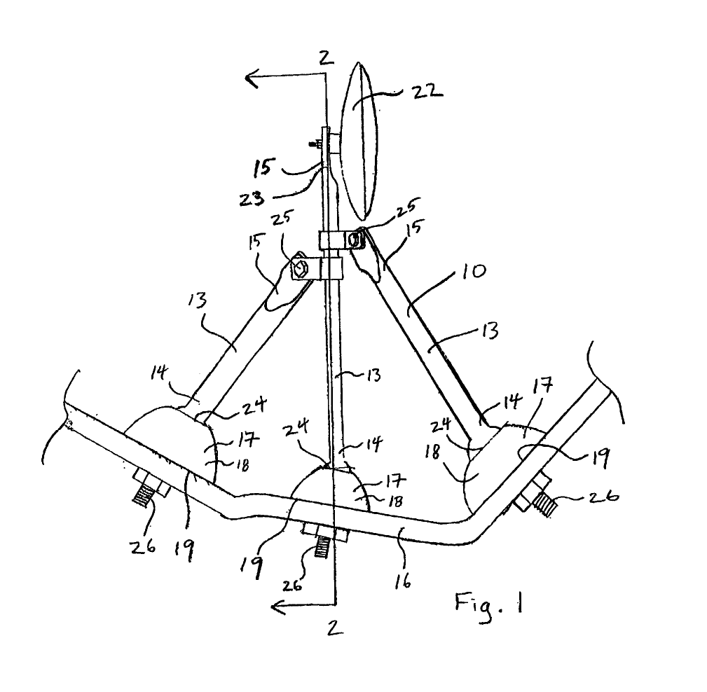

FIG. 2 is a sectional view through line 2-2 of FIG. 1 showing the biaxial pivotal engagement of a base-attachment structure to a support component.

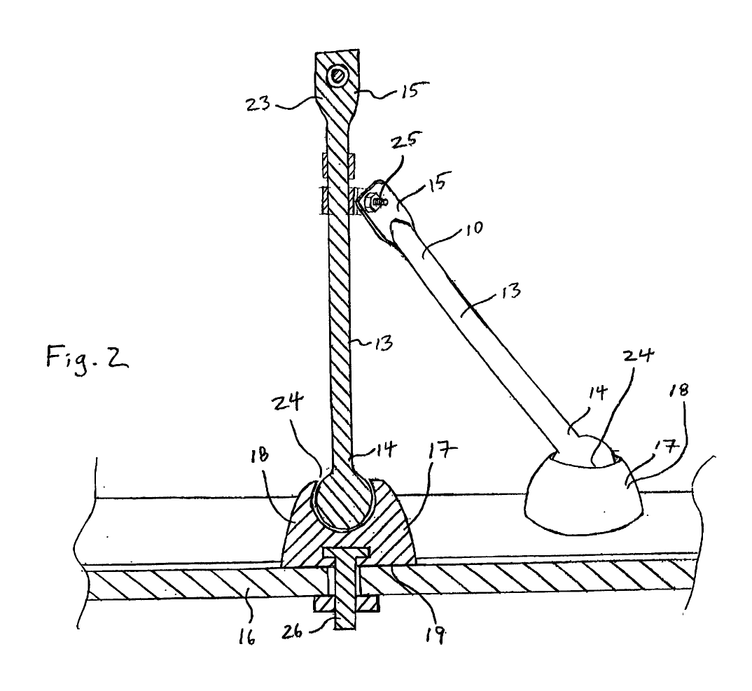

FIG. 3 shows a universal accessory-mounting assembly of the prior art.

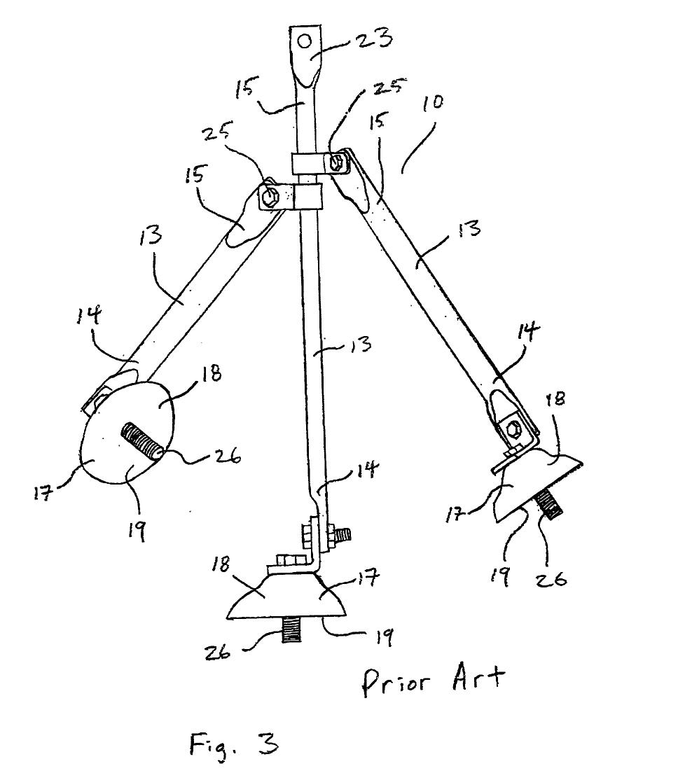

FIG. 4 is a side elevational view of a vehicle with a universal accessory-mounting assembly in accordance with the present invention mounted to a forward end of an engine compartment hood of the vehicle and supporting an accessory, which is a mirror.

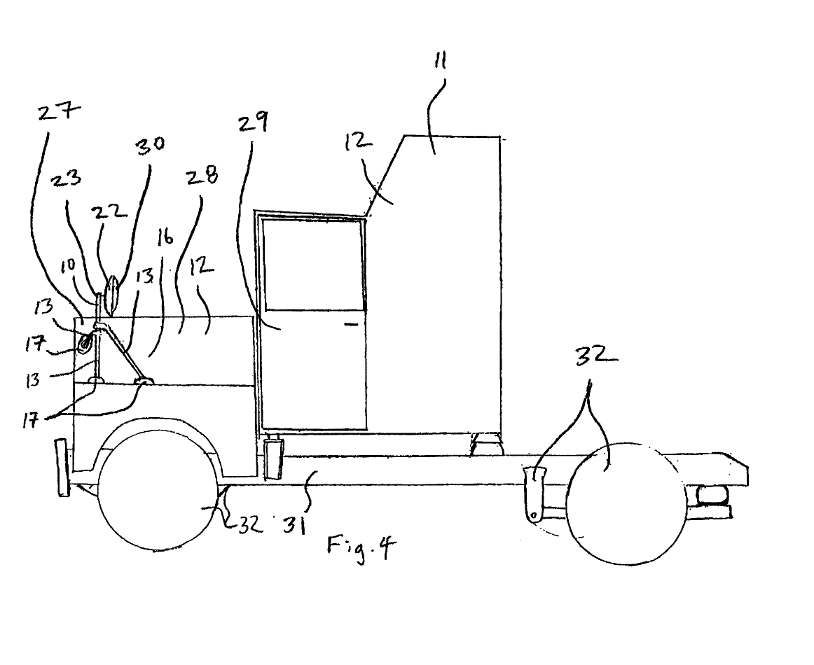

### DETAILS OF INVENTION

The present invention is a universal accessory-mounting assembly 10 for supporting an accessory 22, such as a mirror, at a distance from a base structure 16, such as a body structure 12 of a vehicle 11. The universal accessory-mounting assembly 10 of the present invention includes one or more support components 13 which are engaged to the base structure 16 by at least two independent base-attachment structures 17, which are engaged to base ends 14 of the support component(s) 13 and which are attached to the base structure 16, when the universal accessory-mounting assembly 10 is properly mounted to the base structure 16. The universal accessory-mounting assembly 10 also comprises accessory-attachment structure 23 to which the accessory 22 is mounted and from which the accessory 22 derives support. The accessory-attachment structure 23 may be a single component or it may be multiple components. The accessory-attachment structure 23 is engaged directly or indirectly to an accessory-support end 15 of each of the support components 13. The accessory-attachment structure 23 may, in fact, comprise one or more of the accessory-support ends 15 of the support components 13.

One or more of the two or more base-attachment structures 17 of the universal accessory-mounting assembly 10 are biaxally pivotally engaged to a base end 14 of a support component by ball-and-socket joints 24. The orientation of base-attachment structure 17 engaged to a support component 13 in such a manner can be adjusted about two axes relative to the support component 13 and, therefore, can also be adjusted about two axes relative to other portions of the universal accessory-mounting assembly 10 and also a base structure 16 to which it is or will be mounted. The biaxial adjustability of the orientation of each base-attachment structure 17 that is engaged to a base end 14 of a support component 13 through a ball-and-socket joint 24 allows for easy alignment of the base-attachment structure 17 to a portion of the base structure 16 to which the base-attachment structure 17 is to be attached. Each ball-and-socket joint 24 through which a base-attachment structure 17 is engaged to a base end 14 of a support component 13 may be of any of a number of constructions well known to or easily imaginable by one of ordinary skill in the art. In the preferred embodiment of the universal accessory-mounting assembly 10 each of the support components 13, to which a base attachment structure 17 is engaged by a ball-and-socket joint 24 is of unitary construction. It is because the base-attachment structures 17 are engaged to the support components 13 through ball-and-socket joints 24, that the support components 13 may be of unitary construction and yet the orientation of the base-attachment structures 17 can be adjusted to be properly mounted to base structures 16 of virtually any shape. Of course it will be understood also that base attachment structures 17 of the universal accessory-mounting assembly 10 may be biaxially pivotally engaged to support components 13 yet not be able to move relative to the support components 13 when the universal accessory-mounting assembly 10 is properly mounted to a base structure 16. For example the universal accessory-mounting assembly 10 of the preferred embodiment has three base-attachment structures 17, each of which is biaxially pivotally engaged to a base end 14 of a support component, yet, when the universal accessory-mounting assembly 10 is properly mounted to a base structure 16 these base-attachment structures 17 cannot pivot relative to the support components 13 that they are attached to. For purposes of this disclosure a base-attachment structure 17 that is engaged to a support component 13 through a ball-and-socket joint 24, and is, therefore, biaxially pivotal relative to the support component 13 when the universal accessory-mounting assembly 10 is not mounted to a base structure 16, is considered to be biaxially pivotally engaged to the support component 13 whether or not the universal accessory-mounting assembly 10 is mounted to a base structure 16.

In the preferred embodiment of the universal accessory-mounting assembly 10 no more than one of the base-attachment structures 17 is engaged to a respective base end 14 of a support component 13 in a manner other than being biaxially pivotally engaged to the base end 14 through a ball-and-socket joint 24. Such a construction of the universal accessory-mounting assembly 10, with no less than the total number of base-attachment structures 17 minus one engaged to base ends 14 of support components 13 through ball-and-socket joints 24, ensures that all of the base-attachment structures 17 can be properly aligned and attached to a base structure 16 of virtually any shape. If there is one base-attachment structure 17 that is rigidly engaged to its respective support component 13, that one is aligned to the portion of the base structure 16 to which it is or will be attached and the orientations of all of the other base-attachment structures 17, which are engaged to their respective support components 13 through ball-and-socket joints 24, are adjusted to be properly aligned to the portion of the base structure 16 to which they are or will be attached.

Each support component 13 of the universal accessory-mounting assembly 10 may be engaged to other components of the universal accessory-mounting assembly 10 in any of a number of different ways and may, therefore, be moveable relative to none, some, or all of the other support components 13. The more support components 13 each support component 13 is moveable relative to, the greater is the flexibility of the position in which the accessory 22 can be mounted relative to the base structure 16 to which the universal accessory-mounting assembly 10 is mounted to. In the preferred embodiment, therefore, each of the support components 13 are uniaxially pivotally engaged to one another at a point adjacent their accessory-support end 15. In this preferred embodiment each support component 13 is engaged to each other support component 13 by a pivot bolt 25 that extends through apertures defined through pivot structures 26 of each support component 13. Each pivot structure 26 of each support component 13 is either rigidly engaged to the support component 13 adjacent its accessory-support end 15 or is part of the accessory-support end 15 of the support component 13. The pivot structures 26 of two support components 13 that are uniaxially pivotally engaged to one another by a pivot bolt are captured between a head of the pivot bolt 25 and a nut that is threadedly engaged to the pivot bolt 25. The axis of each pivot bolt 25 of the preferred embodiment of the universal accessory-mounting assembly 10 is the axis about which the two support components 13 engaged to one another by the pivot bolt 25 may rotate relative to one another. Additionally, in the preferred embodiment, in the interest of added stability of the universal accessory-mounting assembly 10 the axis of each of the pivot bolts 25 which engages two support components 13 to one another is oriented at an angle to the axes of each of the other pivot bolts 25. It will also be understood that, while in the preferred embodiment each support component 13 is directly pivotally engaged to another support component 13, a universal accessory-mounting assembly 10 according to the present invention may include one or more intermediate components to which two or more support components 13 are pivotally engaged and through which those support components 13 are, thus, pivotally engaged to one another. Of course it will be understood that there are a number of other structures such as pins or axles that could be utilized to uniaxially pivotally engage the support components 13 to one another. Additionally, in the preferred embodiment, all of the base-attachment structures 17 of the universal accessory-mounting assembly 10 are biaxially pivotally engaged to their respective support components 13 through ball-and-socket joints 24. Thus, the universal accessory mounting assembly 10 of the preferred embodiment can be mounted to base structures 16 of virtually any shape and, through adjustment of the relative orientations its support components 13 are mounted in, can support the accessory anywhere within a wide range of positions relative to the base structure 16. Of course it will be understood also that support components 13 of the universal accessory-mounting assembly 10 may be moveably engaged to one another and yet not be able to move relative to one another when the universal accessory-mounting assembly 10 is properly mounted to a base structure 16. For example the universal accessory-mounting assembly 10 of the preferred embodiment has three support components 13, each of which is uniaxially pivotally engaged to the others, yet, when the universal accessory-mounting assembly 10 is properly mounted to a base structure 16 these support components 13 cannot move relative to one another. For purposes of this disclosure, therefore, support components 13, that are engaged to one another in such a manner that they are uniaxially pivotal relative to one another when the universal accessory-mounting assembly 10 is not mounted to a base structure 16, will be considered uniaxially pivotally engaged to one another whether or not the universal accessory-mounting assembly 10 is mounted to a base structure 16.

While it is desirable to allow the support components 13 to pivot relative to one another during the mounting of the universal accessory-mounting assembly 10 to a base structure 16 so that their relative positions and orientations may be adjusted, it is generally preferable that the support components 13 are relatively rigidly engaged to one another after the universal accessory-mounting assembly 10 is mounted. It is preferable that the support components 13 be relatively rigidly engaged to one another after the universal accessory-mounting assembly 10 is mounted to minimize undesirable movement of the accessory 22 relative to the base structure 16. For this reason a universal accessory-mounting assembly 10 that includes support components 13, which are uniaxially pivotally engaged to one another may also include structure to selectively secure the angular orientation of the support components 13 relative to one another. According to the present invention pivoting of one support component 13 relative to another is prevented, and the support components 13 are relatively rigidly located relative to one another by clamping the pivot structures 26 of the support components 13 between the head of the pivot bolt 25 that engages them to one another and the nut that is threadedly engaged to the pivot bolt 25. In order to allow adjustment of the orientations of the support components 13 relative to one another during mounting of the universal accessory-mounting assembly 10, the nut that is threadedly engaged to each pivot bolt 25 can be loosened. Of course it will be understood that there are a number of structures that are well known and/or easily imaginable by one of ordinary skill in the art that could be utilized to engage the support components 13 to one another in such a manner that they can selectively be allowed to rotate relative to one another or relatively rigidly engaged to one another. Additionally detent structures may be used at the interface between the support components 13 to deter rotation of the support components 13 relative to one another while still allowing such rotation to occur for adjustment purposes during mounting if sufficient forces are applied to the support components 13.

The support components 13 of the universal accessory-mounting assembly 10 may be any of many different constructions that are well-known and/or easily imaginable by one of ordinary skill in the art. Additionally, the universal accessory-mounting assembly 10 may have any number of support components 13 and any number of base-attachment structures 17 greater than or equal to two. In the preferred embodiment, the universal accessory-mounting assembly 10 includes three support components 13, each of which is a relatively long, thin member and is relatively straight. Additionally the preferred embodiment of the universal accessory-mounting assembly 10 includes three base-attachment structures 17, each of which is engaged to the base-end 14 of one of the three support components 13. The reasons that the preferred number of base-attachment structures 17 is three involve economics, simplicity, and structural integrity of the universal accessory-mounting assembly 10 and the base structure 10 to which it is mounted. For economic reasons and in the interest of simplicity, it is preferred to use the fewest number of support components 13 and base attachment structures 17 that will function as needed. It is also true that the support components 13 of a universal accessory-mounting assembly 10 with three or more base-attachment structures 17 will be subjected to primarily only tension and compression forces and only minimal moments. In a similar manner the base-attachment structures 17 of a universal accessory-mounting assembly 10 which includes at least three base-attachment structures 17 apply primarily forces and only negligible if any moments to the portions of the base structure 16 to which they are attached. Thus, it can be seen that a universal accessory-mounting assembly 10 that includes three base-attachment structures 17 provides a good combination of structural integrity of the universal accessory-mounting assembly 10 and the base structure 16 to which it is mounted, economy, and simplicity. It is for similar reasons related to structural integrity that a universal accessory-mounting assembly 10 which two base-attachment structures 17, while not the preferred embodiment, is preferred over a universal accessory-mounting assembly 10 that includes only one base-attachment structure 16.

The base-attachment structures 17 of the universal accessory-mounting assembly 10 may be constructed in any of a number of ways well known and/or easily imaginable by one of ordinary skill in the art. In the preferred embodiment each of the base-attachment structures 13 comprises a mounting pad 18 that defines a flat mounting-face 19 that abuts the surface of the of the base structure 16 when the universal accessory-mounting assembly 10 is mounted to the base structure 16. Also, in the preferred embodiment, each base-attachment structure 17 comprises a threaded stud 26, which may be the shaft of a bolt, that projects from the flat mounting-face 19 of the mounting pad 18. When such a base-attachment structure 17 is properly attached to a base structure 16, the threaded stud 26 is threadedly engaged to female threaded structure disposed within the base structure 16 or to a nut disposed upon a side of the base structure 16 opposite the mounting pad 18 and the threaded stud 26 is engaged to the female threaded structure to an extent that the flat mounting-face 19 is firmly pressed against the base structure 16. It will of course be understood that the means for securing the base-attachment structure 17 to the base structure 16 may, alternatively, have a male fastener component that protrudes from the base structure 16 and a female fastener component engaged to the mounting pad 18 of the base-attachment structure 17. It will also be understood that many types of fasteners other than threaded, including but not limited to various types of rivets, clips, quick engagement retainers etc., may be used for securing the base-attachment structure 17 to the base structure 16.

The accessory-attachment structure 23 of the universal accessory-mounting assembly 10 may have any of a number of different constructions and may be engaged to the rest of the universal accessory-mounting assembly 10 in any of a number of different ways. The accessory-attachment structure 23 is, as was described above, the structure from which the accessory 22, which is mounted to the universal accessory-mounting assembly 10, derives support. The accessory-attachment structure 23 may comprise one or more components that are engaged to the accessory-support ends 15 of the support components 13. In the preferred embodiment the accessory 22 is mounted directly to an accessory-support end 15 of one of the support components 13 and, thus, the accessory-support end 15 of the support component 13, to which the accessory 22 is mounted, constitutes the accessory-support structure 23 of the universal accessory-mounting assembly 10.

There are many different applications for which the universal accessory-mounting assembly 10 of the present invention is well suited and, thus, there are many different types of base structures 16 to which it may be mounted and there are many different types of accessories 22 which would be advantageously mounted to it. In the preferred embodiment, the universal accessory-mounting assembly 10 of the present invention is utilized to mount an accessory such as a mirror, a light, or an antenna at a distance from a base structure 16 that is a body structure 12 of a vehicle 11. In the preferred embodiment the universal accessory-mounting assembly 10 of the present invention is mounted to a forward end 27 of an engine compartment hood 28 of a vehicle 10. Also in the preferred embodiment, the accessory 22 that is mounted to the universal accessory-mounting assembly 10 is a mirror 30 that faces at least partially toward a cab 29 of the vehicle 10 so that a driver of the vehicle 10 may view images of areas in front of, beside, and/or behind the vehicle in the mirror 30.

A vehicle 11 to which the universal accessory-mounting assembly 10 of the present invention may be mounted could be constructed in any of large number of different ways. Such a vehicle 11 would include one or more frame structures 31 to which a large percentage of other components of the vehicle 11 are engaged directly or indirectly and from which those components derive support directly or indirectly. Such a vehicle 11 would also include a suspension system 32 that is engaged to the one or more frame structures 31 of the vehicle 11 and which functions to support the frame structures 31 above the ground and to provide the vehicle 11 with a relatively low resistance to movement along the ground. Such a vehicle 11 would also include one or more body structures 12 which are engaged to and supported by the one or more frame structures 31 and within or upon which passengers and/or cargo may reside during movement of the vehicle 11. A vehicle 11 to which the universal accessory-mounting assembly 10 of the present invention is preferably mounted includes additional systems including a powertrain, a cab 29, and an engine compartment hood 28. The powertrain of the vehicle 11 of the preferred embodiment is engaged to the frame structures 31 and the suspension system 32 of the vehicle 11 in such a manner to be operable to motivate the vehicle 11. The cab 29 of the vehicle 11 is, as is well known, a body structure 12 of the vehicle 11 from which a driver of the vehicle 11 may control operation of the vehicle 11. The engine compartment hood 28 is another body structure 12 of the vehicle 10, which is generally disposed in front of the cab 29 of the vehicle 11 and which covers an engine of the powertrain of the vehicle 11.

It will be understood by those skilled in the art that in some instances some features of the invention will be employed without a corresponding use of other features. It will also be understood by those skilled in the art that modifications could be made to the invention as described without departing from the spirit and scope of the invention and thus the scope of the invention is limited only by the following claims.

We claim:

1. A universal accessory-mounting assembly for supporting an accessory at a distance from a base structure to which the universal accessory-mounting assembly may be attached, comprising:
(a) one or more support components each of which has a base end and an accessory-support end;
(b) wherein each support component has its accessory-support end engaged directly or indirectly to accessory-support ends of every other support component;
(c) two or more independent base-attachment structures each of which is engaged to a base end of one of said support components;
(d) wherein each of said base-attachment structures comprises means for securing it to the base structure;
(e) wherein one or more of said base-attachment structures are biaxially pivotally engaged to said base end of one of said support component(s) by a ball-and-socket joint;
(f) accessory-attachment structure to which the accessory may be mounted; and
(g) wherein said accessory-attachment structure is engaged directly or indirectly to and/or comprises one or more of said accessory-support ends of said support components.

2. The universal accessory-mounting assembly of claim 1, wherein:
(a) one or less of said base-attachment structures are engaged to a base end of a support component in a manner other than being biaxially pivotally engaged through a ball-and-socket joint.

3. The universal accessory-mounting assembly of claim 2, wherein:
(a) said universal accessory-mounting assembly comprises two or more support components;
(b) one or more of said support components is/are engaged directly or indirectly to other support component in such a manner that it/they are at least selectively movable relative to said other support components.

4. The universal accessory-mounting assembly of claim 3, wherein:
(a) one or more of said support components is/are uniaxially pivotally engaged directly or indirectly to all others of said support components and its/their orientations is/are, therefore, uniaxially pivotally adjustable relative to all others of said support components.

5. The universal accessory-mounting assembly of claim 4, wherein:
(a) every one of said base-attachment structures is biaxially pivotally engaged to a base end of one of said support components through a ball-and-socket joint.

6. The universal accessory-mounting assembly of claim 5, wherein:
(a) for each support component, which is directly or indirectly uniaxially pivotally engaged to other support components, said universal accessory-mounting assembly includes structure which can be utilized to selectively secure its orientation relative to all others of said support components.

7. The universal accessory-mounting assembly of claim 6, wherein:
(a) every one of said support components is directly or indirectly uniaxially pivotally engaged to all others of said support components.

8. The universal accessory-mounting assembly of claim 7, wherein:
(a) each axis about which each support component is pivotal relative to other support components is disposed at an angle to all other axes about which all other support components are pivotal.

9. The universal accessory-mounting assembly of claim 8, wherein:
(a) each of said base attachment structures comprises a mounting pad which has a flat mounting-face which is firmly pressed against the base structure when said universal accessory-mounting assembly is mounted to the base structure.

10. The universal accessory-mounting assembly of claim 9, wherein:
(a) said universal accessory-mounting assembly comprises three support components and three base-attachment structures.

11. The universal accessory-mounting assembly of claim 10, wherein:
(a) each of said support components is a relatively long, thin, member and is of unitary construction.

12. The universal accessory-mounting assembly of claim 2, wherein:
(a) every one of said base-attachment structures is biaxially pivotally engaged to a base end of one of said support components through a ball-and-socket joint.

13. The universal accessory-mounting assembly of claim 12, wherein:
(a) said universal accessory-mounting assembly comprises three support components and three base-attachment structures.

14. The universal accessory-mounting assembly of claim 13, wherein:
(a) one or more of said support components is/are engaged directly or indirectly to other support component in such a manner that it/they are at least selectively movable relative to said other support components.

15. The universal accessory-mounting assembly of claim 14, wherein:
(a) every one of said support components is directly or indirectly uniaxially pivotally engaged to all others of said support components.

16. The universal accessory-mounting assembly of claim 1, wherein:
(a) said universal accessory-mounting assembly comprises three support components and three base-attachment structures.

17. The universal accessory-mounting assembly of claim 2, wherein:
(a) said universal accessory-mounting assembly comprises three support components and three base-attachment structures.

18. A vehicle, comprising:
(a) one or more frame structures to which a large percentage of other components of said vehicle are directly or indirectly engaged and from which said components which are directly or indirectly engaged thereto derive support;
(b) a suspension system which is engaged to said one or more frame structures of said vehicle and which supports said one or more frame structures of said vehicle above the ground and provides said vehicle with a relatively low resistance to movement along the ground;
(c) one or more body structures, which are engaged to and supported by said one or more frame structures and within or upon which passengers and/or cargo may reside;
(d) a universal accessory-mounting assembly that is mounted to a base structure which is one of said body structures of said vehicle;
(h) wherein said universal accessory-mounting assembly comprises one or more support components each of which has a base end and an accessory-support end;
(i) wherein each support component has its accessory-support end engaged directly or indirectly to accessory-support ends of every other support component;
(j) wherein said universal accessory-mounting assembly comprises two or more independent base-attachment structures each of which is engaged to a base end of one of said support components and each of which is also attached to said vehicle body structure which is said base structure;
(k) wherein one or more of said base-attachment structures are biaxially pivotally engaged to said base end of one of said support component(s) by a ball-and-socket joint;
(l) wherein said universal accessory-mounting assembly further comprises accessory-attachment structure to which an accessory is mounted; and
(m) wherein said accessory-attachment structure is engaged directly or indirectly to and/or comprises one or more of said accessory-support ends of said support components.

19. The vehicle of claim 18, wherein:
(a) one or less of said base-attachment structures are engaged to a base end of a support component in a manner other than being biaxially pivotally engaged through a ball-and-socket joint.

20. The vehicle of claim 19, wherein:
(a) said universal accessory-mounting assembly comprises two or more support components;
(b) one or more of said support components is/are engaged directly or indirectly to other support component in such a manner that it/they are at least selectively movable relative to said other support components.

21. The vehicle of claim 20, wherein:
(a) one or more of said support components is/are uniaxially pivotally engaged directly or indirectly to all others of said support components and its/their orientations is/are, therefore, uniaxially pivotally adjustable relative to all others of said support components.

22. The vehicle of claim 21, wherein:
(a) every one of said base-attachment structures is biaxially pivotally engaged to a base end of one of said support components through a ball-and-socket joint.

23. The vehicle of claim 22, wherein:
(a) for each support component, which is directly or indirectly uniaxially pivotally engaged to other support components, said universal accessory-mounting assembly includes structure which can be utilized to selectively secure its orientation relative to all others of said support components.

24. The vehicle of claim 23, wherein:
(a) every one of said support components is directly or indirectly uniaxially pivotally engaged to all others of said support components.

25. The vehicle of claim 24, wherein:
(a) each axis about which each support component is pivotal relative to other support components is disposed at an angle to all other axes about which all other support components are pivotal.

26. The vehicle of claim 25, wherein:
(a) each of said base attachment structures comprises a mounting pad which has a flat mounting-face which is firmly pressed against said body structure of said vehicle that is said base structure.

27. The vehicle of claim 26, wherein:
(a) said universal accessory-mounting assembly comprises three support components and three base-attachment structures.

28. The vehicle of claim 27, wherein:
(a) each of said support components is a relatively long, thin, member and is of unitary construction.

29. The vehicle of claim 19, wherein:
(a) every one of said base-attachment structures is biaxially pivotally engaged to a base end of one of said support components through a ball-and-socket joint.

30. The vehicle of claim 29, wherein:
(a) said universal accessory-mounting assembly comprises three support components and three base-attachment structures.

31. The vehicle of claim 30, wherein:
(a) one or more of said support components is/are engaged directly or indirectly to other support component in such a manner that it/they are at least selectively movable relative to said other support components.

32. The vehicle of claim 31, wherein:
(a) every one of said support components is directly or indirectly uniaxially pivotally engaged to all others of said support components.

33. The vehicle of claim 18, wherein:
(a) said universal accessory-mounting assembly comprises three support components and three base-attachment structures.

34. The vehicle of claim 19, wherein:
(a) said universal accessory-mounting assembly comprises three support components and three base-attachment structures.

35. The vehicle of claim 18, wherein:
(a) said accessory that is mounted to said universal accessory-mounting assembly is selected from a group consisting of lights, antennas, and mirrors.

36. The vehicle of claim 35, wherein:
(a) said body structures which said vehicle comprises include a cab and an engine compartment hood disposed in front of said cab;
(b) said base structure to which said universal accessory-mounting assembly is mounted is said engine compartment hood;
(c) said universal accessory-mounting assembly is mounted at a forward end of said engine compartment hood; and
(d) said accessory that is mounted to said universal accessory-mounting assembly is a mirror a reflecting surface of which is directed at least partially toward said cab such that a driver of said vehicle can view images of areas in front of, beside, or behind, said vehicle in said reflecting surface of said mirror.

37. The vehicle of claim 19, wherein:
(a) said accessory that is mounted to said universal accessory-mounting assembly is selected from a group consisting of lights, antennas, and mirrors.

38. The vehicle of claim 37, wherein:
(a) said body structures which said vehicle comprises include a cab and an engine compartment hood disposed in front of said cab;
(b) said base structure to which said universal accessory-mounting assembly is mounted is said engine compartment hood;
(c) said universal accessory-mounting assembly is mounted at a forward end of said engine compartment hood; and
(d) said accessory that is mounted to said universal accessory-mounting assembly is a mirror a reflecting surface of which is directed at least partially toward said cab such that a driver of said vehicle can view images of areas in front of, beside, or behind, said vehicle in said reflecting surface of said mirror.

39. The vehicle of claim 30, wherein:
(a) said accessory that is mounted to said universal accessory-mounting assembly is selected from a group consisting of lights, antennas, and mirrors.

40. The vehicle of claim 39, wherein:
(a) said body structures which said vehicle comprises include a cab and an engine compartment hood disposed in front of said cab;
(b) said base structure to which said universal accessory-mounting assembly is mounted is said engine compartment hood;
(c) said universal accessory-mounting assembly is mounted at a forward end of said engine compartment hood; and
(d) said accessory that is mounted to said universal accessory-mounting assembly is a mirror a reflecting surface of which is directed at least partially toward said cab such that a driver of said vehicle can view images of areas in front of, beside, or behind, said vehicle in said reflecting surface of said mirror.
